(19) United States
(12) Patent Application Publication
(10) Pub. No.: US 2021/0302172 A1
(43) Pub. Date: Sep. 30, 2021

(54) ACCOMMODATION AREA MANAGEMENT DEVICE

(71) Applicant: HONDA MOTOR CO., LTD., Tokyo (JP)

(72) Inventors: Gaku SHIMAMOTO, Saitama (JP); Junpei NOGUCHI, Saitama (JP); Yuta TAKADA, Tokyo (JP); Ryoma TAGUCHI, Tokyo (JP)

(73) Assignee: HONDA MOTOR CO., LTD., Tokyo (JP)

(21) Appl. No.: 17/211,383

(22) Filed: Mar. 24, 2021

(30) Foreign Application Priority Data
Mar. 30, 2020 (JP) 2020-061635

(51) Int. Cl. G01C 21/34; G08G 1/123

(52) U.S. Cl. CPC G01C 21/3407; G08G 1/123

(57) ABSTRACT

A parking lot management device which manages a parking lot for accommodating a vehicle, includes a route generation unit which generates a traveling route for guiding the vehicle to a target position, and a processor which guides the vehicle to the target position based on the generated traveling route. The route generation unit generates a first traveling route and a second traveling route whose traveling direction or traveling method is different from that of the first traveling route. The processor selects the first traveling route or the second traveling route based on a traveling environment from a current position of the vehicle to the target position and guides the vehicle to the target position based on the selected traveling route.

### CROSS-REFERENCE TO RELATED APPLICATIONS

The present application claims the benefit of priority of Japanese Patent Application No. 2020-061635, filed on Mar. 30, 2020, the content of which is incorporated herein by reference.

### TECHNICAL FIELD

The present invention relates to an accommodation area management device which manages an accommodation area capable of accommodating a moving body.

### BACKGROUND

JP-A-2007-219738 discloses a technique in which a self-driving control device which controls automatic traveling of a vehicle automatically travels the vehicle to a predetermined parking frame and parks the vehicle based on parking information from a parking information management device.

### SUMMARY

However, in the technique of the related art, there is room for improvement in selection of a traveling route and a traveling method when traveling a moving body such as a vehicle in an accommodation area which can accommodate the moving body. For example, in the technique of the related art, a technique of using reverse traveling when traveling a moving body in an accommodation area is not sufficiently studied.

The present invention provides an accommodation area management device capable of appropriately selecting a traveling route when traveling a moving body in an accommodation area.

An embodiment of the present invention is an accommodation area management device which manages an accommodation area for accommodating a moving body, comprising.

a route generation unit configured to generate a traveling route for guiding the moving body to a target position: and

a processor configured to guide the moving body to the target position based on the generated traveling route, wherein

the route generation unit generates a first traveling route and a second traveling route whose traveling direction or traveling method is different from that of the first traveling route, and

the processor selects the first traveling route or the second traveling route based on a traveling environment from a current position of the moving body to the target position and guides the moving body to the target position based on the selected traveling route.

According to the embodiment of the present invention, it is possible to appropriately select a traveling route when traveling the moving body in the accommodation area.

### BRIEF DESCRIPTION OF DRAWINGS

FIG. 1 is a diagram illustrating an example of a configuration of a vehicle system of an embodiment.

FIG. 2 is a diagram illustrating an example of a parking lot managed by a parking lot management device of the embodiment.

FIG. 3 is a diagram illustrating an example of a configuration of the parking lot management device.

FIG. 4 is a diagram illustrating an example of a parking reservation table.

FIG. 5 is a diagram illustrating an example of a parking space status table.

FIG. 6 is a flowchart illustrating a series of processing flows of the parking lot management device.

### DESCRIPTION OF EMBODIMENT

Hereinafter, an embodiment of an accommodation area management device of the present invention will be described with reference to the accompanying drawings. In the following embodiment, an example will be described in which a moving body in the present invention is a vehicle and an accommodation area in the present invention is a parking lot.

Further, in the following embodiment, an example in which the accommodation area management device of the present invention is used as a parking lot management device for managing a parking lot will be described.

Vehicle System

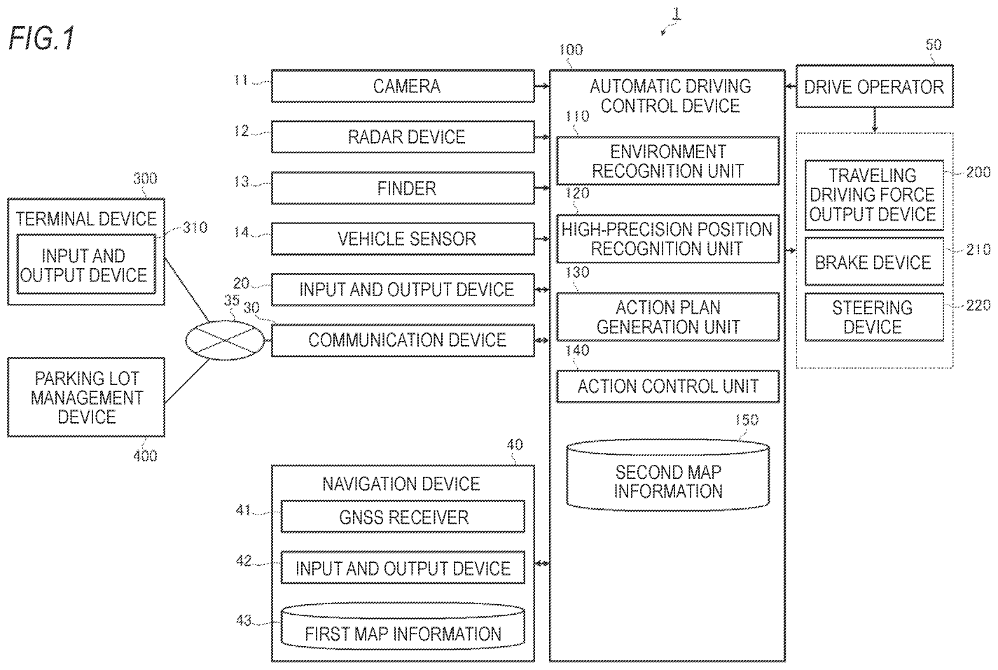

First, a vehicle of the embodiment will be described. In FIG. 1, a vehicle system 1 is mounted on a vehicle having an automatic driving function of a so-called automatic driving level “4” or higher. A vehicle (hereinafter, also referred to as vehicle M) equipped with the vehicle system 1 is a vehicle including a drive source and wheels (for example, two wheels, three wheels, or four wheels) including driving wheels driven by the power of the drive source. The drive source of the vehicle M is, for example, an electric motor. Further, the drive source of the vehicle M may be an internal combustion engine such as a gasoline engine or a combination of an electric motor and an internal combustion engine.

As illustrated in FIG. 1, the vehicle system 1 includes a camera 11, a radar device 12, a finder 13, a vehicle sensor 14, an input and output device 20, a communication device 30, a navigation device 40, a drive operator 50, an automatic driving control device 100, a traveling driving force output device 200, a brake device 210, and a steering device 220. Each of those devices is communicably connected to each other by a wired or wireless communication network. The communication network connecting each of those devices is, for example, Controller Area Network (CAN).

The camera 11 is a digital camera which photographs the periphery (for example, in front of vehicle M) of the vehicle M and outputs image data obtained by the photographing to the automatic driving control device 100. The radar device 12 is, for example, a radar device using radio waves in a millimeter wave band, detects a position of an object in the vicinity (for example, in front of, behind, and to the side of vehicle M) of the vehicle M, and outputs the detection result to the automatic driving control device 100.

The finder 13 is, for example, Laser Imaging Detection and Ranging (LIDAR). The finder 13 uses a predetermined laser beam to measure the distance to an object (target object) around (for example, in front of, behind, and to the side of vehicle M) the vehicle M and outputs the measurement result to the automatic driving control device 100.

The vehicle sensor 14 includes, for example, a vehicle speed sensor which detects the speed of the vehicle M, an acceleration sensor which detects the acceleration of the vehicle M, an angular velocity sensor which detects the angular velocity around a vertical axis of the vehicle M, an orientation sensor which detects the orientation of the vehicle M, and the like. Further, the vehicle sensor 14 includes a radio wave intensity sensor which detects the radio wave intensity (that is, the communication intensity) of the radio wave used by the communication device 30, described later, for communication. The vehicle sensor 14 outputs the detection result of each sensor to the automatic driving control device 100 or the like.

The input and output device 20 includes an output device which outputs various kinds of information to a user of the vehicle M and an input device which accepts various input operations from the user of the vehicle M. The output device of the input and output device 20 is, for example, a display which displays based on a processing result of the automatic driving control device 100. The output device may be a speaker, a buzzer, an indicator light, or the like. The input device of the input and output device 20 is, for example, a touch panel or an operation button (key, switch, or the like) which outputs an operation signal corresponding to an input operation received from a user to the automatic driving control device 100.

The communication device 30 is connected to a network 35 and communicates with another device provided outside the vehicle system 1 via the network 35. The network 35 includes, for example, a mobile communication network, a Wi-Fi network, Bluetooth (registered trademark), Dedicated Short Range Communication (DSRC), and the like.

The communication device 30 communicates with, for example, a terminal device 300 carried by a user of the vehicle M, a parking lot management device 400 which manages a parking lot PA where the vehicle M can be parked. The terminal device 300 is, for example, a smartphone or a tablet terminal and is an electronic device connected to the network 35 and including an input and output device 310. The input and output device 310 is, for example, a display which displays various information to a user, a touch panel which accepts a user's input operation, and the like. The parking lot PA and the parking lot management device 400 will be described below.

The navigation device 40 includes a Global Navigation Satellite System (GNSS) receiver 41 and an input and output device 42. Further, the navigation device 40 includes a storage device (not illustrated) such as a flash memory and first map information 43 is stored in this storage device. The first map information 43 is, for example, information representing a road shape by a link indicating a road and a node connected by the link. Further, the first map information 43 may include information representing the curvature of the road and the Point Of Interest (POI).

The GNSS receiver 41 identifies the latitude and longitude of a point where the vehicle M is located as the position of the vehicle M based on the signal received from the GNSS satellite. Further, the navigation device 40 may specify or correct the position of the vehicle M by an Inertial Navigation System (INS) using the output of the vehicle sensor 14.

The input and output device 42 includes an output device which outputs various kinds of information to a user of the vehicle M and an input device which accepts various input operations from a user of the vehicle M. The output device of the input and output device 42 is, for example, a display which displays (for example, displays a route on a map described below) based on the processing result of the navigation device 40. Further, the input device of the input and output device 42 is, for example, a touch panel or an operation button (key, switch, or the like) which outputs an operation signal corresponding to the input operation received from a user to the navigation device 40. The input and output device 42 may be shared with the input and output device 20.

For example, the navigation device 40 determines a route (hereinafter, also referred to as a route on the map) from the position of the vehicle M specified by the GNSS receiver 41 to a destination input by the user with reference to the first map information 43. Then, the navigation device 40 guides the determined route on the map to the user by the input and output device 42. Further, the navigation device 40 outputs information indicating the position of the vehicle M specified by the GNSS receiver 41 and information indicating the determined route on the map to the automatic driving control device 100.

The navigation device 40 may be realized by the function of the terminal device 300. Also, for example, the communication device 30 may transmit information indicating the position of the vehicle M and the destination input by a user to a server device (navigation server) outside the vehicle system 1 and the function of the navigation device 40 may be realized by this server device.

The drive operator 50 is various operators such as an accelerator pedal, a brake pedal, a shift lever, a steering wheel, a deformed steering wheel, and a joystick. The drive operator 50 is provided with a sensor which detects the amount of operation or the presence or absence of operation on the drive operator 50. The detection result by the sensor of the drive operator 50 is output to a part or all of the automatic driving control device 100, the traveling driving force output device 200, the brake device 210, and the steering device 220.

The traveling driving force output device 200 outputs a traveling driving force (torque) for the vehicle M to travel to the driving wheels. The traveling driving force output device 200 includes, for example, an electric motor and an electric motor Electronic Control Unit (ECU) which controls the electric motor. The electric motor ECU controls the electric motor based on the detection result by the sensor of the drive operator 50 (for example, the accelerator pedal) and the control information from the automatic driving control device 100. Further, when the vehicle M includes an internal combustion engine or a transmission as a drive source, the traveling driving force output device 200 may include an internal combustion engine or a transmission and an ECU for controlling the combustion engine or the transmission.

The brake device 210 includes, for example, a brake caliper, a cylinder which transmits hydraulic pressure to the brake caliper, an electric motor which generates hydraulic pressure in the cylinder, and a brake ECU. Based on the detection result by the sensor of the drive operator 50 (for example, the brake pedal) and the control information from the automatic driving control device 100, the brake ECU controls the electric motor of the brake device 210 so that the brake torque corresponding to the braking operation is output to each wheel.

The steering device 220 includes, for example, a steering ECU and an electric motor. The electric motor of the steering device 220, for example, applies a force to the rack and pinion mechanism to change the direction of the steering wheel. Based on the detection result by the sensor of the drive operator 50 (for example, the steering wheel) and the control information from the automatic driving control device 100, the steering ECU drives the electric motor of the steering device 220 to change the direction of the steering wheels.

Automatic Driving Control Device

The automatic driving control device 100 includes an environment recognition unit 110, a high-precision position recognition unit 120, an action plan generation unit 130, and an action control unit 140. Further, the automatic driving control device 100 includes a storage device (not illustrated) realized by a flash memory or the like to which each functional unit (for example, high-precision position recognition unit 120) of the automatic driving control device 100 can access and second map information 150 is stored in this storage device.

The second map information 150 is more accurate map information than the first map information 43. The second map information 150 includes, for example, information indicating the center of a lane, information indicating a lane boundary line (for example, a road lane marking), and the like. Further, the second map information 150 may include road information, traffic regulation information, address information, facility information, telephone number information, and the like.

Further, the second map information 150 may be updated at any time by the communication device 30 communicating with another device. For example, when the vehicle M enters the parking lot PA, the communication device 30 receives information (hereafter, also referred to as in-parking-lot map information) indicating the lane in the parking lot PA, the position of each parking space, and the like from the parking lot management device 400. Then, the automatic driving control device 100 updates the second map information 150 so as to incorporate the received in-parking-lot map information into the second map information 150. As a result, the automatic driving control device 100 can specify the position of each parking space in the parking lot PA with reference to the second map information 150.

The environment recognition unit 110 performs sensor fusion processing on information acquired by a part or all of the camera 11, the radar device 12, and the finder 13, in such a manner that the environment recognition unit 110 recognizes an object around the vehicle M and recognizes its position. The environment recognition unit 110 recognizes, for example, an obstacle, a road shape, a traffic light, a guardrail, a utility pole, a surrounding vehicle (including traveling conditions such as speed and acceleration and parking conditions), a lane mark, a pedestrian, and the like and recognizes their positions.

Referring to the position of the vehicle M specified by the navigation device 40, the detection result by the vehicle sensor 14, the image taken by the camera 11, the second map information, and the like, the high-precision position recognition unit 120 recognizes the detailed position and attitude of the vehicle M. The high-precision position recognition unit 120 recognizes, for example, the traveling lane in which the vehicle M is traveling or recognizes the relative position and attitude of the own vehicle with respect to the traveling lane. Further, the high-precision position recognition unit 120 also recognizes, for example, the position of the vehicle M in the parking lot PA.

The action plan generation unit 130 generates an action plan for the vehicle M. Specifically, the action plan generation unit 130 generates a target track on which the vehicle M will travel in the future as an action plan of the vehicle M. The target track is, for example, information in which points (track points) to be reached by the vehicle M are arranged for each predetermined traveling distance (for example, about several [m]). Further, the target track may include information on speed elements such as the target speed and the target acceleration of the vehicle M at each predetermined time or at each track point. The action plan generation unit 130 generates an action plan according to the instructions of the parking lot management device 400 received by the communication device 30, for example.

The action control unit 140 controls the vehicle M to act according to the action plan generated by the action plan generation unit 130. Specifically, the action control unit 140 controls the traveling driving force output device 200, the brake device 210, and the steering device 220 so that the vehicle M passes the target track generated by the action plan generation unit 130 at the scheduled time. The action control unit 140 controls, for example, the traveling driving force output device 200 and the brake device 210 based on the speed element associated with the target track and controls the steering device 220 according to a curvature degree of the target track.

Each functional unit included in the automatic driving control device 100 is realized, for example, by the Central Processor (CPU) executing a predetermined program (software). Further, a part or all of the functional units of the automatic driving control device 100 may be realized by hardware such as Large Scale Integration (LSI), Application Specific Integrated Circuit (ASIC), Field-Programmable Gate Array (FPGA), Graphics Processor (GPU), and for example, the storage device for storing the second map information 150 and the high-precision position recognition unit 120 may be realized by a Map Positioning Unit (MPU). Further, a part or all of the functional units of the automatic driving control device 100 may be realized by the cooperation of software and hardware.

Parking Lot Managed by Parking Lot Management Device

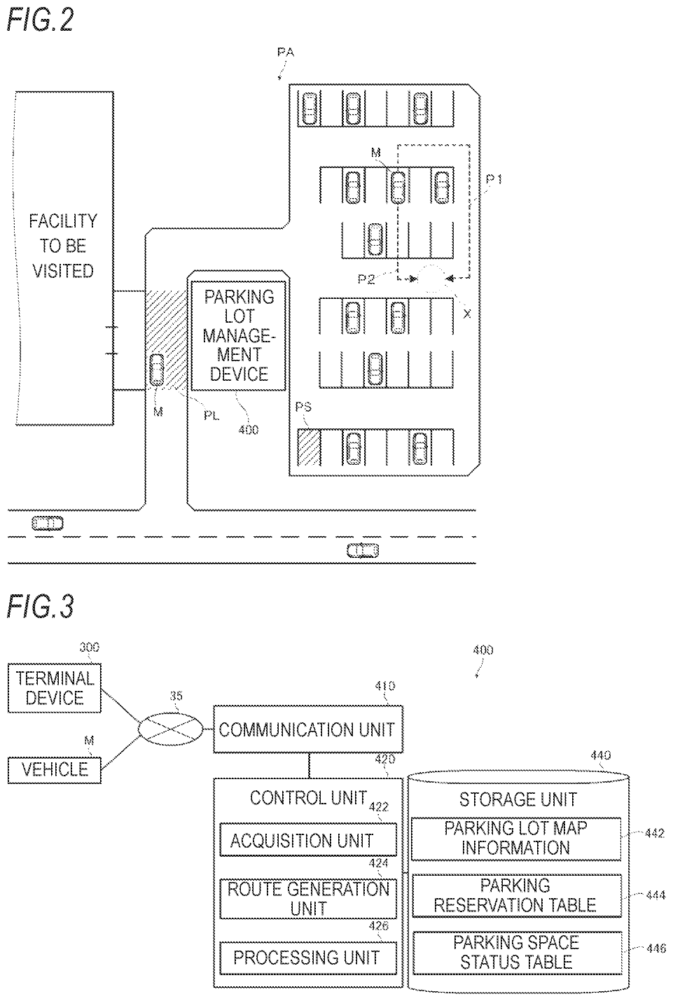

Next, an example of the parking lot PA will be described with reference to FIG. 2. As illustrated in FIG. 2, the parking lot PA is a parking lot managed by the parking lot management device 400 and is an automatic valet parking type parking lot attached to a visited facility to be visited by a user. The parking lot PA includes a plurality of parking spaces PS where a vehicle (for example, vehicle M) can be accommodated and a platform PL provided right before the plurality of parking spaces PS. Hereinafter, an example in which a user of the vehicle M uses the parking lot PA will be described.

Before using the parking lot PA, a user of the vehicle M makes a reservation for using the parking lot PA to the parking lot management device 400 which manages the parking lot PA by using own terminal device 300 or the like. For example, the user inputs own identification information (for example, a user ID described below), the identification information (for example, the vehicle ID described below) of the vehicle M to be parked, a date and time when the parking lot PA is used (for example, a reserved time zone described below), and the like to the terminal device 300 and transmits this information to the parking lot management device 400, in such a manner that the user makes a reservation for using the parking lot PA. Then, when the date and time of the reservation is reached, the user drives the vehicle M to the platform PL and gets off from the vehicle M at the platform PL.

After the user gets off the vehicle M, the vehicle M automatically drives and starts a self-propelled parking event to move to the parking space PS in the parking lot PA. For example, the user sends a request to start a self-propelled entry event to move the vehicle M to the parking space PS to the parking lot management device 400 by using own terminal device 300 or the like. In response to the request to start the self-propelled entry event, the parking lot management device 400 instructs the vehicle M to perform the self-propelled entry event to park in a predetermined parking space PS. According to this instruction, the vehicle M moves to the parking space PS instructed by the parking lot management device 400 while performing guiding by the parking lot management device 400 and sensing with the camera 11, the radar device 12, the finder 13, or the like.

In addition, the vehicle M parked in the parking lot PA can carry out re-parking, so-called “reparking”, in which the parking position is changed to another parking position in the parking lot PA. Reparking is appropriately carried out by a control instruction by the parking lot management device 400 or a voluntary automatic driving by the vehicle M itself.

In addition, at the time of exit from the parking lot PA, the vehicle M is automatically driven and performs a self-propelled exit event to move from the parked parking space PS to the platform PL. For example, the user uses own terminal device 300 or the like to send a request for starting the self-propelled exit event to move the vehicle M to the platform PL to the parking lot management device 400. In response to the request to start the self-propelled exit event, the parking lot management device 400 instructs vehicle M to perform the self-propelled exit event to move the vehicle M from the parked parking space PS to the platform PL. According to this instruction, the vehicle M moves to the platform PL while performing guiding by the parking lot management device 400 and sensing with the camera 11, the radar device 12, the finder 13, or the like. Then, the user gets on the vehicle M which has reached the platform PL and exits from the parking lot PA.

Parking Lot Management Device Next, an example of a configuration of the parking lot management device 400 will be described with reference to FIG. 3. As illustrated in FIG. 3, the parking lot management device 400 includes, for example, a communication unit 410, a control unit 420, and a storage unit 440. The control unit 420 includes, for example, an acquisition unit 422, a route generation unit 424, and a processor 426. Each component of the control unit 420 is realized, for example, by a hardware processor such as a CPU executing a program (software). Some or all of those components may be realized by hardware (circuit part; including circuitry) such as LSI, ASIC, FPGA, and GPU, or may be realized by collaboration between software and hardware. The program may be stored in advance in a storage device (a storage device including a non-transient storage medium) such as an HDD or a flash memory or the program may be stored in a removable storage medium (non-transient storage medium) such as a DVD or a CD-ROM and installed by attaching the storage medium to a drive device.

The storage unit 440 stores information such as parking lot map information 442, parking reservation table 444, and a parking space status table 446. The storage unit 440 is realized by an HDD, a flash memory, or the like.

The communication unit 410 wirelessly (for example, network 35) communicates with the vehicle M or the terminal device 300 of the user. The control unit 420 guides the vehicle M to the parking space PS based on the information acquired by the communication unit 410 and the information stored in the storage unit 440. The parking lot map information 442 is information which geometrically represents the structure of the parking lot PA. Further, the parking lot map information 442 includes the coordinates for each parking space PS.

A parking reservation for the vehicle M is input to the acquisition unit 422 from the terminal device 300 of the user of the vehicle M using the communication unit 410. When the parking reservation of the vehicle M is input, the acquisition unit 422 registers the input parking reservation in the parking reservation table 444 of the storage unit 440.

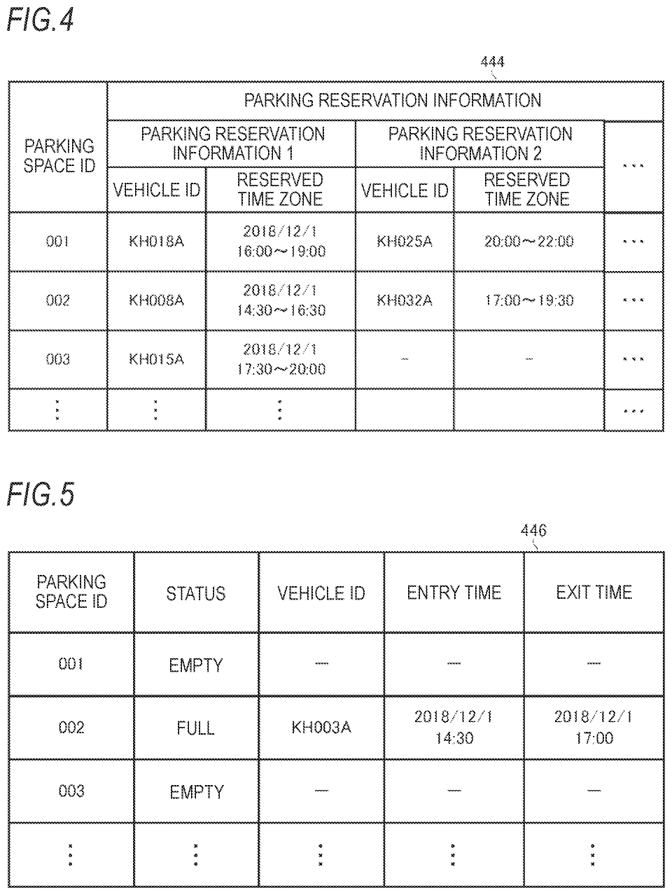

As illustrated in FIG. 4, the parking reservation table 444 stores, for example, parking reservation information in association with a parking space ID, which is identification information of the parking space PS. The parking reservation information includes, for example, information indicating the vehicle ID which is identification information of the vehicle M to be parked and a reserved time zone in which the vehicle M is scheduled to be parked in the parking lot PA. Further, the parking reservation information may include a user ID which is identification information of the user of the vehicle M to be parked.

Further, the acquisition unit 422 can also acquire the position information of the vehicle M already parked in the parking lot PA via the communication unit 410. This position information is stored, for example, in the form of the parking space status table 446. As illustrated in FIG. 5, in the parking space status table 446, the parking space ID, which is the identification information of the space PS, is associated with information indicating whether the parking space PS is empty or full, the Vehicle ID, which is the identification information of the parked vehicle M when the parking space PS is full, and the entry time and exit time (scheduled exit time) of the vehicle M when the parking space PS is full. The entry time and exit time are recorded, for example, in association with the vehicle ID of the vehicle M when the vehicle M enters the parking lot PA. The vehicle ID can be, for example, a vehicle number written on a vehicle number plate (so-called license plate).

In addition, the acquisition unit 422 can also acquire the position information of each vehicle M traveling in the parking lot PA. For example, the vehicle M traveling in the parking lot PA periodically transmits information which associates the vehicle ID of the own vehicle with the position (for example, the position recognized by the high-precision position recognition unit 120) of the own vehicle in the parking lot PA to the parking lot management device 400. The acquisition unit 422 acquires information in which the vehicle ID transmitted from the vehicle M traveling in the parking lot PA and the position in the parking lot PA are associated with each other via the communication unit 410. Further, when the parking lot management device 400 receives the information in which the vehicle ID and the position in the parking lot PA are associated with each other from the vehicle M traveling in the parking lot PA, the parking lot management device 400 may store the received information in a predetermined table of the storage unit 440. Then, the acquisition unit 422 may acquire the position information of the vehicle M traveling in the parking lot PA with reference to this table.

By the way, when the vehicle M parked in the parking lot PA exits or reparks, the parking lot management device 400 determines a traveling route to be traveled by the vehicle M from a current position of the vehicle M to a predetermined target position and guides the vehicle M to travel on this traveling route. Here, the target position can be a destination that is a final movement destination, for example, the platform PL in the case of exiting, the parking space PS of the repark destination in the case of reparking, and the like. Further, the target position may be a waypoint that goes through to reach the destination, for example, a position on a passage in the parking lot PA. That is, the target position is not limited to the destination and may be a stop position (hereinafter, also referred to as a temporary stop position) where the vehicle M is temporarily stopped until the vehicle M reaches the final destination such as the platform PL.

When the vehicle M travels in the parking lot PA, it is generally moved by forward traveling. However, by adopting reverse traveling, it is possible to conceive that the movement of the vehicle M can be completed in a short time or a short distance as compared with the case of movement by forward traveling, and thus the movement of the vehicle M can be performed efficiently.

Therefore, the parking lot management device 400 of the embodiment generates a first traveling route P1 and a second traveling route P2 whose traveling direction or traveling method is different from that of the first traveling route P1, and then the parking lot management device 400 selects the first traveling route P1 or the second traveling route P2 based on a traveling environment from the current position of the vehicle M to a target position. Here, the second traveling route P2 is, for example, a route having a higher ratio of reverse traveling than the first traveling route P1.

Further, here, the traveling environment includes, for example, a distance from the current position of the vehicle M to the target position by each of the first traveling route P1 and the second traveling route P2 and the number of curves, the height difference, the required number of turns, and the like in each of the first traveling route P1 and the second traveling route P2. The processor 426 selects the first traveling route P1 or the second traveling route P2 based on such a traveling environment, in such a manner that it is possible to select the traveling route which takes less time from the current position of the vehicle M to the target position and which consumes less energy (for example, battery power or gasoline consumption) of the vehicle M. Then, the processor 426 guides the vehicle M according to the selected traveling route. As a result, the parking lot management device 400 can appropriately select the traveling route when traveling the vehicle M in the parking lot PA, and thus it is possible to efficiently move the vehicle M in the parking lot PA.

For example, when, by adopting the reverse traveling, the movement of the vehicle M is completed in a short time or a short distance as compared with the case of moving by the forward traveling, the parking lot management device 400 can efficiently move the vehicle M in the parking lot PA by positively adopting the reverse traveling. As a result, the parking lot management device 400 can effectively utilize the parking lot PA.

Specifically, the route generation unit 424 generates a traveling route for guiding the vehicle M to the target position. Here, the route generation unit 424 generates a first traveling route P1 and a second traveling route P2 whose traveling direction or traveling method is different from that of the first traveling route P1. As described above, the second traveling route P2 is, for example, a route having a higher ratio of reverse traveling than that of the first traveling route P1.

The processor 426 selects either the first traveling route P1 or the second traveling route P2 based on the traveling environment such as the distance from the current position of the vehicle M to the target position and guides the vehicle M according to the selected traveling route. That is, the processor 426 transmits the selected traveling route to the vehicle M using the communication unit 410.

Upon receiving the traveling route, the vehicle M generates an action plan including a target track based on the traveling route by the action plan generation unit 130. Then, the action control unit 140 controls the vehicle M to act according to the action plan generated by the action plan generation unit 130. As a result, the vehicle M travels on the traveling route selected by the parking lot management device 400.

The first traveling route P1 generated by the route generation unit 424 always includes a forward traveling route (route where vehicle is moved by forward traveling). Therefore, although, in the first traveling route P1, the forward traveling route may be 100%, it may include a reverse traveling route (route where vehicle is moved by reverse traveling). For example, the first traveling route P1 can be a traveling route such that the ratio of the forward traveling route to the reverse traveling route is 9:1.

Further, the second traveling route P2 generated by the route generation unit 424 always includes a reverse traveling route. Therefore, although, in the second traveling route P2, the reverse traveling route may be 100%, it may include a forward traveling route. For example, the second traveling route P2 can be a traveling route such that the ratio of the forward traveling route to the reverse traveling route is 2:8.

FIG. 2 illustrates an example of the first traveling route P1 and the second traveling route P2 generated in the case of exiting. The example of FIG. 2 is an example in which, for the vehicle M to exit from the parking lot, it stops at a target position X as a temporary stop position until it reaches the exit of the parking lot PA or the platform PL. In this case, the processor 426 generates the first traveling route P1 and the second traveling route P2 illustrated in FIG. 2. The ratio of reverse traveling is higher in the second traveling route P2 than in the first traveling route P1. The processor 426 selects either the first traveling route P1 or the second traveling route P2 based on the traveling environment such as the distance from the current position of the vehicle M to the target position X which is a temporary stop position.

The processor 426 selects, for example, a traveling route having a shorter distance to the target position from the first traveling route P1 and the second traveling route P2. In the example of FIG. 2, since the second traveling route P2 has a shorter distance than the first traveling route P1, the processor 426 selects the second traveling route P2 having a high ratio of reverse traveling. As a result, the vehicle M can be traveled on the traveling route where the distance to the target position is shorter to reach the target position X, and thus for example, the energy (for example, battery power) consumption of the vehicle M required to move to the target position X can be suppressed.

Even when the distance to the target position of the second traveling route P2 is shorter than that of the first traveling route P1, when a scheduled travel time to the target position by the second traveling route P2 exceeds a predetermined time, it is desirable that the processor 426 selects the first traveling route P1. Here, the scheduled travel time to the target position by the second traveling route P2 is, for example, a predicted value of the required time from the current position of the vehicle M to the target position by the second traveling route P2.

That is, as will be described below, for example, when the vehicle M is driven backward, the speed may be lower than that during the forward traveling. In this case, even when the distance to the target position of the second traveling route P2 is shorter than that of the first traveling route P1, there is a possibility that the scheduled travel time to the target position by the second traveling route P2 exceeds a predetermined time. Therefore, when the scheduled travel time to the target position by the second traveling route P2 exceeds a predetermined time, that is, when it takes a long time to move to the target position by the second traveling route P2, by selecting the first traveling route P1, an appropriate traveling route can be selected.

Further, the predetermined time described above includes, for example, a time of traveling on a traveling route overlapping with a traveling route of another vehicle M, a time of turning the vehicle M, and the like. This makes it possible to select an appropriate traveling route in consideration of the fact that an operation that is expected to require a certain amount of time is performed.

Further, the processor 426 may select, for example, a traveling route predicted to have a shorter time required to reach the target position among the first traveling route P1 and the second traveling route P2. As a result, the vehicle M can be travel on the traveling route that shortens the time required to reach the target position and can reach the target position X. Therefore, for example, the vehicle M can smoothly exit from the parking lot PA or perform reparking.

In addition, the parking lot PA includes a track environment in which reverse traveling is possible. Specifically, for example, as illustrated in FIG. 2, the parking lot PA is provided with a parking space PS capable of allowing the vehicle M to enter and exit by traveling forward and enter and exit by traveling backward. As a result, the second traveling route P2 including the reverse traveling can be generated.

The route generation unit 424 may generate a traveling route which includes a parking space PS in which a vehicle is not parked. That is, by passing through the parking space PS where none of the vehicles M of the parking spaces PS provided in the parking lot PA is parked as a shortcut, it is conceivable that the movement to the target position can be performed in a short time or a short distance. Therefore, the route generation unit 424 refers to the parking space status table 446 and the like to generate a traveling route including the parking space PS in which none of the vehicles M is parked as a part of the route, it is possible to generate a traveling route which allows the vehicle M to move efficiently.

Further, when one of the traveling routes of the first traveling route P1 and the second traveling route P2 overlaps with a traveling route of another vehicle, the processor 426 can select the other traveling route. As a result, it is possible to avoid the traveling route of the another vehicle M, and thus the vehicle M can be moved smoothly.

For example, the parking lot management device 400 manages and stores a traveling route for each vehicle traveling in the parking lot PA. The traveling route of each vehicle managed and stored by the parking lot management device 400 is, for example, a traveling route generated by the parking lot management device 400 for each vehicle. However, it may be a traveling route generated by each vehicle itself and notified to the parking lot management device 400. The processor 426 refers to traveling route information of each vehicle stored in the parking lot management device 400, in such a manner that it is possible to determine whether the first traveling route P1 or the second traveling route P2 overlaps with the traveling route of another vehicle and to select the traveling route which does not overlap with the traveling route of another vehicle.

Further, when both the first traveling route P1 and the second traveling route P2 overlap with the traveling route of another vehicle, the route generation unit 424 may generate a third traveling route which is at least partially different from the first traveling route P1 and the second traveling route P2. As a result, the vehicle M can be moved so as to avoid the traveling route of the another vehicle M, and thus the vehicle M can be moved smoothly. The third traveling route may partially overlap with the first traveling route P1 or the second traveling route P2, or may be entirely different from the first traveling route P1 and the second traveling route P2. Further, the third traveling route includes forward traveling or reverse traveling, and for example, the ratio of reverse traveling may be higher than that of the first traveling route P1 and lower than that of the second traveling route P2. Further, the third traveling route may be a route in which the ratio of reverse traveling is higher than that of the second traveling route P2. As a result, it is possible to generate the third traveling route which can efficiently move the vehicle M, including reverse traveling.

Further, the processor 426 may cause the vehicle M to travel at a lower speed when the vehicle M travels backward than when the vehicle M travels forward. For example, the vehicle M is designed mainly for forward traveling. Therefore, for example, it is assumed that the sensing performance for the rear of the vehicle M is lower than the sensing performance for the front of the vehicle M. Therefore, when the vehicle M travels backward, the safety of the traveling vehicle M can be ensured by allowing the vehicle M to travel at a lower speed than when the vehicle M travels forward.

Further, the processor 426 guides the vehicle M to the target position according to the selected traveling route by transmitting a predetermined control signal to the vehicle M via, for example, the communication unit 410. As a result, the vehicle M can be reliably controlled so as to move to the target position according to the selected traveling route.

Processing Flow

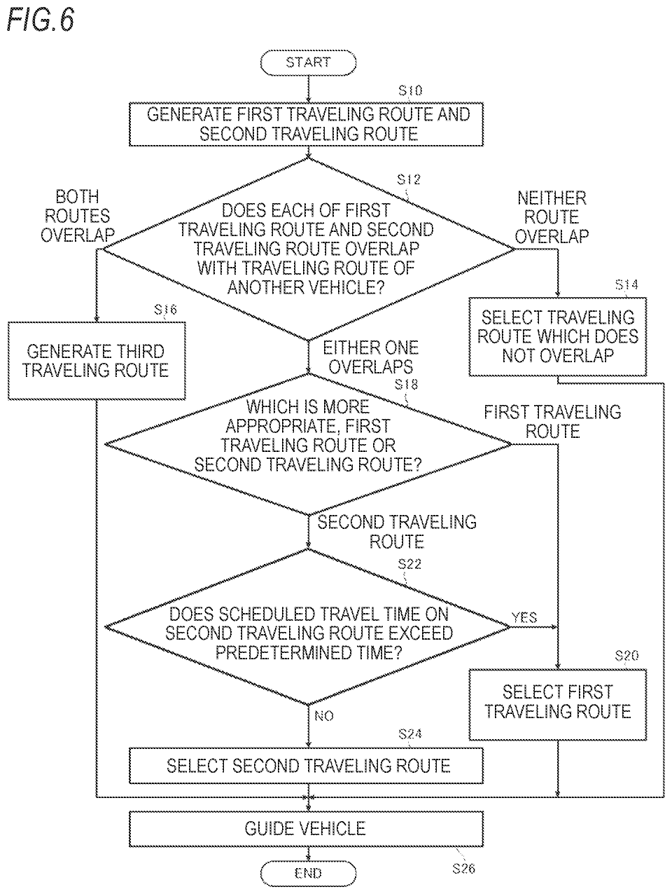

Hereinafter, a series of processing flows of the parking lot management device 400 will be described with reference to FIG. 6. The process illustrated in FIG. 6 may be repeated at a predetermined cycle.

First, when the vehicle M is moved to the target position, the parking lot management device 400 generates the first traveling route P1 and the second traveling route P2 as traveling routes to the target position (Step S10). Next, the parking lot management device 400 determines whether each of the generated first traveling route P1 and second traveling route P2 overlaps with a traveling route of another vehicle M (Step S12).

When either one of the first traveling route P1 and the second traveling route P2 overlaps with the traveling route of the another vehicle M, the parking lot management device 400 selects the other traveling route which does not overlap with the traveling route of the another vehicle M (Step S14), and then the process proceeds to Step S26.

Further, when both the first traveling route P1 and the second traveling route P2 overlap with the traveling route of the another vehicle M, the parking lot management device 400 generates and selects a third traveling route different from the first traveling route P1 and the second traveling route P2 (Step S16), and then the process proceeds to Step S26.

Further, when both the first traveling route P1 and the second traveling route P2 do not overlap with the traveling route of the another vehicle M, the parking lot management device 400 determines which of the first traveling route P1 and the second traveling route P2 is appropriate (Step S18). In Step S18, for example, referring to the distance to the target position by each of the first traveling route P1 and the second traveling route P2, the number of curves in each of the first traveling route P1 and the second traveling route P2, the height difference, and the like, the parking lot management device 400 determines which of the first traveling route P1 and the second traveling route P2 is appropriate (for example, which one of them requires a shorter time to reach the target position). When it is determined that the first traveling route P1 is more appropriate, the parking lot management device 400 selects the first traveling route P1 (Step S20) and proceeds to the process of Step S26.

When it is determined that the second traveling route P2 is more appropriate, the parking lot management device 400 determines whether the scheduled travel time on the second traveling route P2 exceeds a predetermined time (Step S22). When the scheduled travel time on the second traveling route P2 exceeds the predetermined time (YES in Step S22), the parking lot management device 400 shifts to the process of Step S20.

When the scheduled travel time on the second traveling route P2 does not exceed the predetermined time (NO in Step S22), the parking lot management device 400 selects the second traveling route P2 (Step S24) and proceeds to the process of Step S26. Then, the parking lot management device 400 transmits the selected traveling route to the vehicle M, guides the vehicle M to the target position by the traveling route (Step S26), and ends the process illustrated in FIG. 6. The parking lot management device 400 causes the vehicle M to travel at a lower speed when traveling backward than when traveling forward.

Further, as described above, in the process of selecting the first traveling route P1 or the second traveling route P2, the traveling route having the shorter time required to reach the target position may be simply selected from the first traveling route P1 and the second traveling route P2. Further, in generating the traveling route, the parking lot management device 400 may generate a traveling route including a parking space PS in which none of the vehicles M is parked.

The embodiment described above is an example in which the moving body is a vehicle and the accommodation area is a parking lot. However, the idea of the present invention is not limited to such an embodiment and is also applied to a moving body (for example, a robot) other than a vehicle. That is, under the concept of the present invention, “parking” is extended to the concept of “stop” and “traveling” is extended to the concept of “movement”, and further the “parking lot management device” of the embodiment is extended to the concept of “accommodation area management device”. The repark also includes an operation of “restopping to change the accommodation position of the stopped moving body to another accommodation position in the accommodation area” or “the stopped moving body moves to another accommodation position in the accommodation area and stops again”.

The embodiment for carrying out the present invention is described above using the embodiment. However, the present invention is not limited to the embodiments and various modifications and substitutions can be made without departing from the gist of the present invention.

In addition, at least the following matters are described in this specification. The components and the like corresponding to those of the embodiment described above are shown in parentheses, but the present invention is not limited thereto.

(1) An accommodation area management device (parking lot management device 400) which manages an accommodation area (parking lot PA) for accommodating a moving body (vehicle M), including;

a route generation unit (route generation unit 424) which generates a traveling route for guiding the moving body to a target position; and

a processor (processor 426) which guides the moving body to the target position based on the generated traveling route, where

the route generation unit generates a first traveling route (first traveling route P1) and a second traveling route (second traveling route P2) whose traveling direction or traveling method is different from that of the first traveling route, and

the processor selects the first traveling route or the second traveling route based on a traveling environment from a current position of the moving body to the target position (target position X) and guides the moving body to the target position based on the selected traveling route.

According to (1), it is possible to appropriately select the traveling route when traveling the moving body in the accommodation area, and thus it is possible to efficiently move the moving body in the accommodation area.

(2) The accommodation area management device according to (1), where

the second traveling route is a route having a higher rate of reverse traveling than the first traveling route.

According to (2), the traveling route when the moving body is traveled in the accommodation area can be appropriately selected, and thus the moving body can be efficiently moved in the accommodation area.

(3) The accommodation area management device according to (1) or (2), where

the processor selects a traveling route having a short distance to the target position or a traveling route having a short required time to the target position from the first traveling route and the second traveling route.

According to (3), the traveling route having a short distance to the target position or the traveling route having a short required time to the target position is selected from the first traveling route and the second traveling route. As a result, the moving body can be efficiently moved in the accommodation area.

(4) The accommodation area management device according to (3), where

the processor selects the first traveling route when a scheduled travel time to the target position of the second traveling route exceeds a predetermined time even when a distance to the target position of the second traveling route is shorter than that of the first traveling route.

According to (4), when the traveling time on the second traveling route is long, the first traveling route can be selected. As a result, an appropriate traveling route can be selected.

(5) The accommodation area management device according to (4), where

the predetermined time includes at least one of a time of traveling on a traveling route overlapping with a traveling route of another moving body and a time of turning the moving body.

According to (5), an appropriate traveling route can be selected in consideration of an operation which requires a certain amount of time.

(6) The accommodation area management device according to any one of (1) to (5), where

the accommodation area is provided with an accommodation position where the moving body accommodated in the accommodation area can be stopped, and

the route generation unit generates a traveling route including the accommodation position where the moving body is not stopped among the accommodation position.

According to (6), it is possible to generate a traveling route capable of efficiently moving the moving body in the accommodation area.

(7) The accommodation area management device according to any one of (1) to (6), where

when one of the first traveling route and the second traveling route overlaps with a traveling route of another moving body, the processor selects the other traveling route.

According to (7), it is possible to move the moving body while avoiding the traveling route of another moving body, and thus the moving body can be moved smoothly.

(8) The accommodation area management device according to any one of (1) to (7), where

when the first traveling route and the second traveling route overlap with a traveling route of another moving body, the route generation unit generates a third traveling route which is at least partially different from the first traveling route and the second traveling route.

According to (8), it is possible to move the moving body while avoiding the traveling route of another moving body, and thus the moving body can be moved smoothly.

(9) The accommodation area management device according to any one of (1) to (8), where

the target position is the accommodation position of the moving body in the accommodation area or a boarding and alighting position where a user can get on or off the moving body.

According to (9), the moving body can be guided to the accommodation position of the moving body or the boarding and alighting position where a user can get on or off the moving body.

(10) The accommodation area management device according to any one of (1) to (9), where

when the moving body travels backward, the processor makes the moving body move at a lower speed than when the moving body travels forward.

According to (10), the safety of the moving body which travels backward can be ensured.

What is claimed is:

1. An accommodation area management device which manages an accommodation area for accommodating a moving body, comprising:
a route generation unit configured to generate a traveling route for guiding the moving body to a target position; and
a processor configured to guide the moving body to the target position based on the generated traveling route, wherein
the route generation unit generates a first traveling route and a second traveling route whose traveling direction or traveling method is different from that of the first traveling route, and
the processor selects the first traveling route or the second traveling route based on a traveling environment from a current position of the moving body to the target position and guides the moving body to the target position based on the selected traveling route.

2. The accommodation area management device according to claim 1, wherein
the second traveling route is a route having a higher rate of reverse traveling than the first traveling route.

3. The accommodation area management device according to claim 1, wherein
the processor selects a traveling route having a short distance to the target position or a traveling route having a short required time to the target position from the first traveling route and the second traveling route.

4. The accommodation area management device according to claim 3, wherein
the processor selects the first traveling route when a scheduled travel time to the target position of the second traveling route exceeds a predetermined time even when a distance to the target position of the second traveling route is shorter than that of the first traveling route.

5. The accommodation area management device according to claim 4, wherein
the predetermined time includes at least one of a time of traveling on a traveling route overlapping with a traveling route of another moving body and a time of turning the moving body.

6. The accommodation area management device according to claim 1, wherein
the accommodation area is provided with an accommodation position where the moving body accommodated in the accommodation area can be stopped, and
the route generation unit generates a traveling route including the accommodation position where the moving body is not stopped among the accommodation position.

7. The accommodation area management device according to claim 1, wherein
when one of the first traveling route and the second traveling route overlaps with a traveling route of another moving body, the processor selects the other traveling route.

8. The accommodation area management device according to claim 1, wherein
when the first traveling route and the second traveling route overlap with a traveling route of another moving body, the route generation unit generates a third traveling route which is at least partially different from the first traveling route and the second traveling route.

9. The accommodation area management device according to claim 1, wherein
the target position is the accommodation position of the moving body in the accommodation area or a boarding and alighting position where a user can get on or off the moving body.

10. The accommodation area management device according to claim 1, wherein
when the moving body travels backward, the processor makes the moving body move at a lower speed than when the moving body travels forward.
